(19) United States
(12) Patent Application Publication
(10) Pub. No.: US 2006/0290576 A1
(43) Pub. Date: Dec. 28, 2006

(54) Mobile bandits

(76) Inventors: John Michael Wagner, Aurora, CO (US); Alison Ann Wagner, Greenwood village, CO (US)

Correspondence Address: JOHN M. WAGNER, 5796 S. BAHAMA CIR EAST, AURORA, CO, 80015, US

(21) Appl. No.: 11/068,217

(22) Filed: Mar. 1, 2005

(51) Int. Cl. H01Q 1/24

(52) U.S. Cl. 343/702

(57) ABSTRACT

Antenna identifier and decorative item to be used for any electronic device that has an exterior antenna.

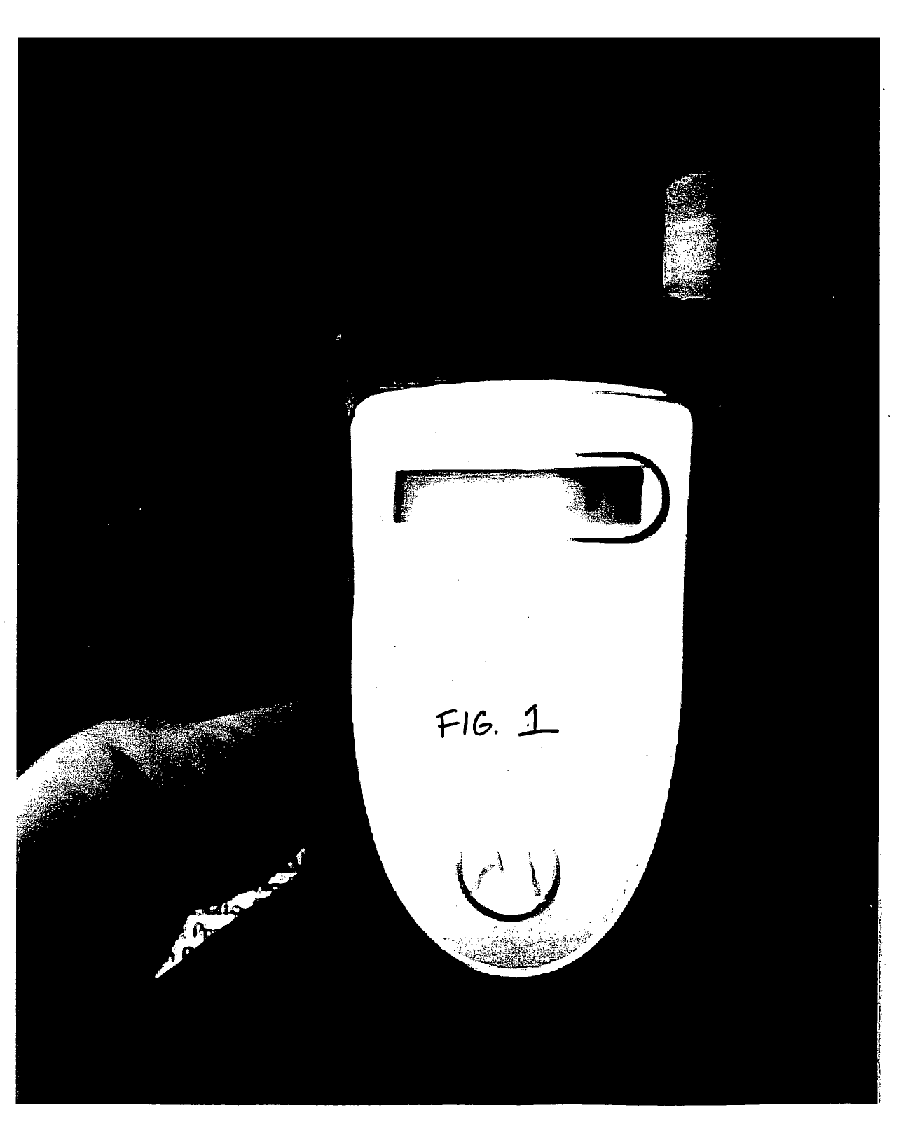

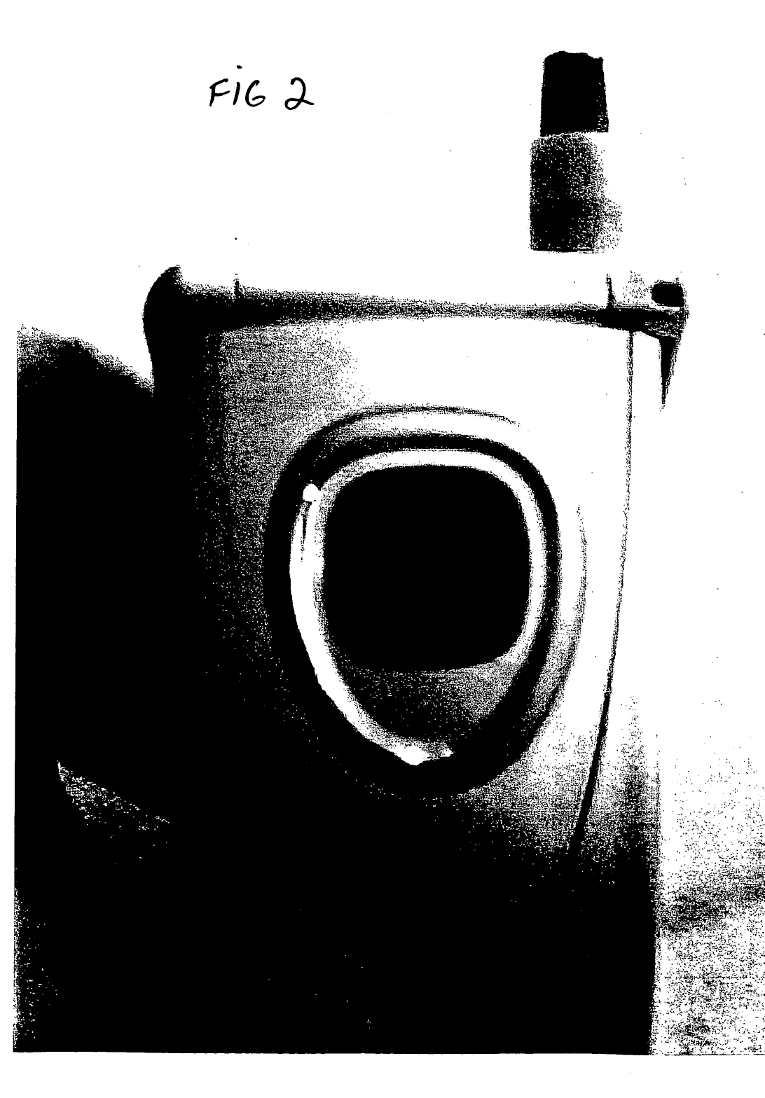

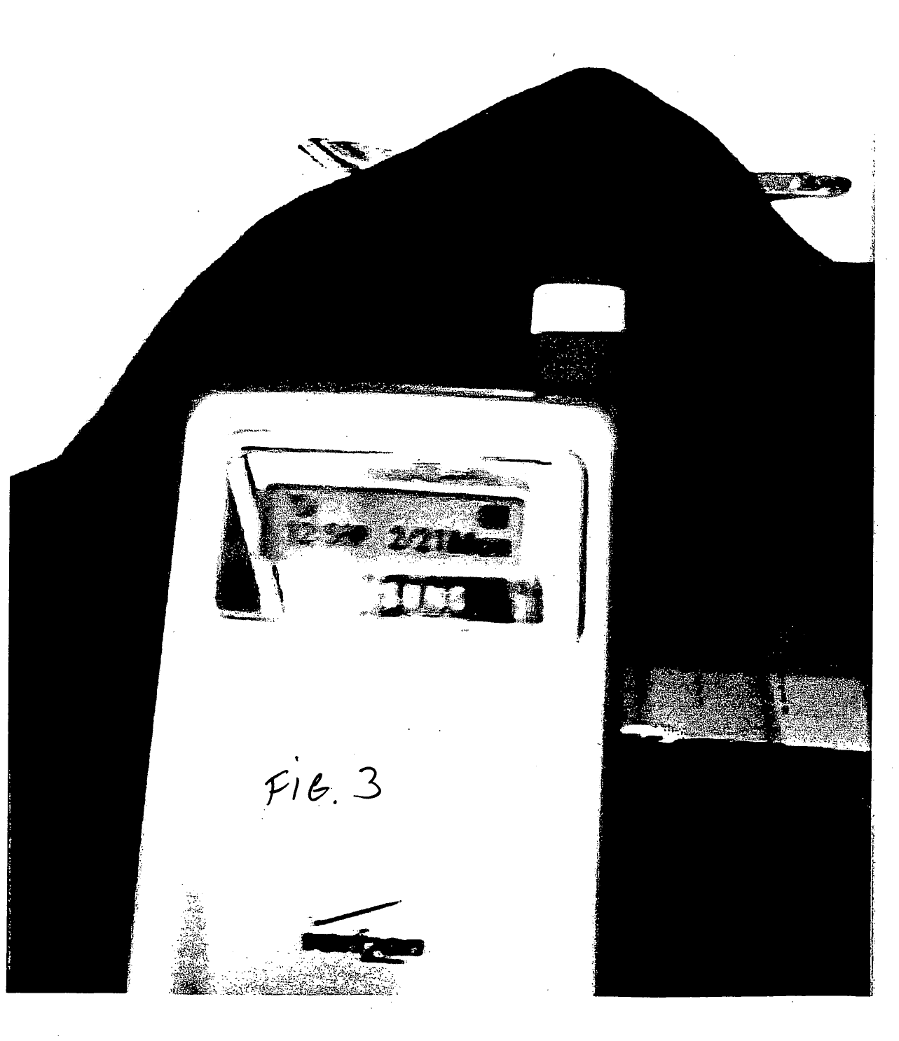

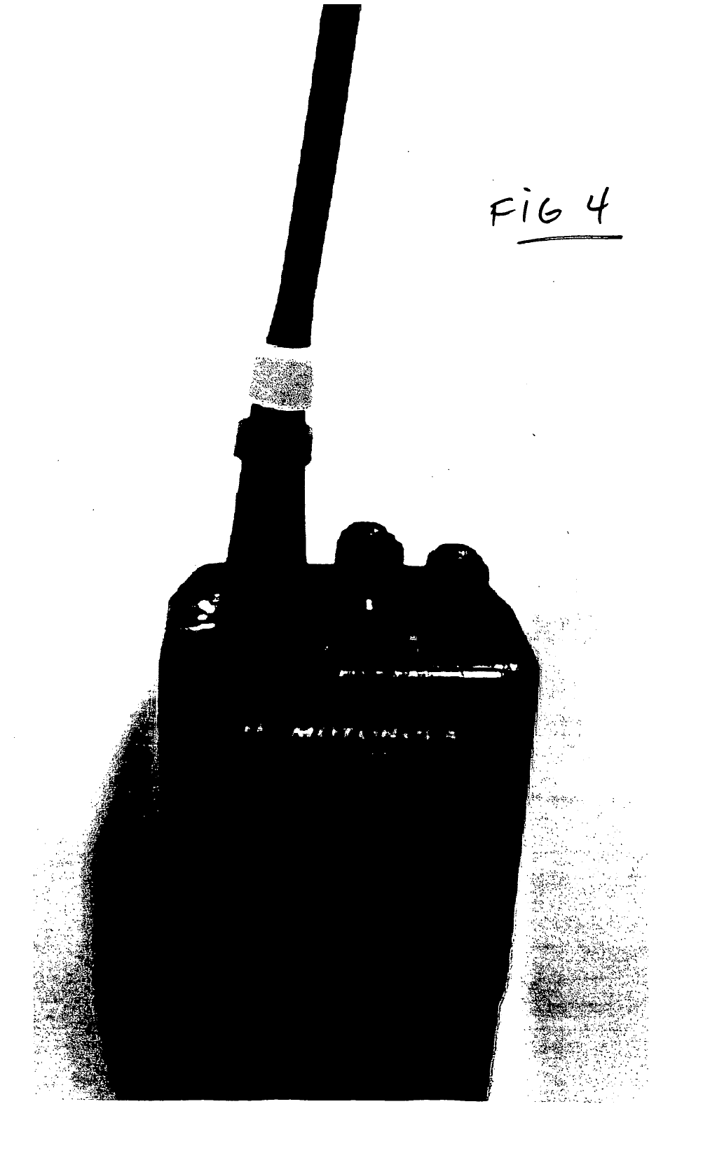

Mobil Bandits are bands that fit over the antenna of electronic devices such as mobile phones or other devices that have external antennas.

The bands can be made of materials such as plastic, rubber, cloth, leather, or metal. They can be used for various purposes, mainly for identification or as a fashion accessory.

What is claimed is:

1. Design, manufacturing and packaging rights for product distribution in wholesale/retail sales application.
